(19) United States
(12) Patent Application Publication
(10) Pub. No.: US 2012/0005357 A1
(43) Pub. Date: Jan. 5, 2012

(54) DELEGATE PROCEDURE FOR AN AUTHENTICATION, AUTHORIZATION AND ACCOUNTING PROTOCOL

(75) Inventor: Vesa Pauli Hellgren, Helsinki (FI)

(73) Assignee: NOKIA SIEMENS NETWORKS OY, Espoo (FI)

(21) Appl. No.: 13/256,247

(22) PCT Filed: Apr. 1, 2009
(86) PCT No.: PCT/EP2009/053886

§ 371 Date: Sep. 13, 2011

(51) Int. Cl. G06F 15/16

(52) U.S. Cl. 709/229

(57) ABSTRACT

According to several embodiments of the present invention, an information element for a first server controlling a first session according to an authentication, authorization and accounting protocol related to a bearer is generated, wherein the information element indicates that there is at least one second session according to the authentication, authorization and accounting protocol with at least one second server related to the same bearer, and that delegation of the first and the at least one second sessions is allowed. Alternatively an information element to be sent from a first server to at least one second server which are connected to a client is generated, wherein there is a first session according to an authentication, authorization and accounting protocol with the client related to a bearer, and the information element includes information for at least one second session according to the authentication, authorization and accounting protocol related to the same bearer, and wherein delegation of the first and the at least one second sessions is allowed.

### FIELD OF THE INVENTION

The present invention relates to an apparatus, method and computer program product for a new delegate procedure of an authentication, authorization and accounting protocol.

### RELATED BACKGROUND ART

The following meanings for the abbreviations used in this specification apply:

3GPP: 3rd generation partnership project

AF application function

AVP: attribute value pair

CCA: credit control answer

CCR: credit control request

IMS: IP multimedia subsystem

IP: internet protocol

IP-CAN: IP continuity access network

LTE: long tem evolution

OCS: online charging system

OFCS: offline charging system

PCC: policy and charging control

PCEF: policy and charging enforcement function

PCRF: policy and charging rules function

QoS: quality of service

Examples of the present invention are related to Diameter protocol as an example for an authentication, authorization and accounting protocol. The base protocol for Diameter is defined in RFC 3588. The base protocol defines how Diameter connection is created between Diameter peers, and how Diameter peers negotiate their capabilities. Diameter base protocol defines also the authentication and accounting procedures based on Diameter commands.

FIG. 5 shows an overview of the PCC (policy and charging control) architecture in 3GPP/SAE. In particular, reference number 1 denotes a subscription profile repository (SPR) in which subscription profiles are stored. Reference number 2 denotes an application function (AF). Reference number 3 denotes a policy and charging rules function (PCRF). The PCRF is a functional element that encompasses policy control decision and flow based on charging control functionalities. Reference number 4 denotes a bearer binding and event reporting function (BBERF). The BBERF is a functional element located in the serving gateway (S-GW) and provides control over the user plane traffic handling and other functionalities, such as bearer handling etc. Reference number 5 denotes an online charging system (OCS), which also comprises a service data flow based credit control 51. Furthermore, reference number 6 denotes a gateway, in which a policy and charging enforcement function (PCEF) 61 is provided. The PCEF encompasses policy enforcement and flow based charging functionalities. In particular, it provides control over the user plane traffic handling at the gateway and provides service data flow detection accounting as well as online and offline charging interactions. Reference number 7 denotes an offline charging system (OFCS).

Between the elements described above, several reference points are defined. Between the SPR and the PCRF, the Sp reference point is defined, via which the PCRF my obtain information such as subscriber and service related data. Between the AF 2 and the PCRF, the Rx reference point is defined, via which the PCRF my obtain information such as session, media and subscriber related information. Between the PCRF and the BBERF, the Gxx reference point is defined, via which the PCRF may obtain bearer related data. Between the PCRF and PCEF the Gx reference point is defined, via which the PCRF may obtain information regarding IP-CAN bearer attributes, request type, subscriber related information and the like from the PCEF. Between the service data flow based credit control 51 of the OCS 5 and the PCEF, the Gy reference point is defined, and between the PCRF and the OFCS, the reference point Gz is defined.

It is possible to extend the basic Diameter protocol defined in RFC 3588 by specifying additional Diameter applications. These applications may define additional Diameter commands and attribute-value pairs (AVPs). For example, Diameter Credit Control Application (DCCA) is defined in RFC 4006. 3GPP uses DCCA in online charging in the Gy interface, based on specification 3GPP 32.299. Diameter Gx and Gxx applications are defined by 3GPP specification 3GPP 29.212. Many other Diameter applications have been defined by 3GPP and IETF for various purposes. Many of the interfaces in the 3GPP and LTE system architecture are based on Diameter.

Even though good architecture definition is based on modular division of functional with little dependencies between the functions, this goal is not always achievable. For example, 3GPP has specified that Gy interface is used for online charging and Gx interface is used for policy and charging control (PCC). The Diameter server in the Gy interface is called OCS (Online Charging System) and in the Gx interface the server is PCRF (Policy and Charging Rule Function). No interface is defined between OCS and PCRF, so online charging and policy and charging control are completely independent interfaces. This is problematic for policy control, because the policies may depend on the usage of the resources and the billing account information of the subscriber. For example, fair usage policies may be defined in such a way that policies will be changed after some monthly limit is exceeded. Gx application defined in 3GPP 29.212 does not allow reporting the usage of resources to PCRF, so implementing the fair usage policies is not possible based on the current Diameter Gx application.

Another related problem is the need to define more granular policy control, where some of the policies are defined by special PCRF nodes and generic PCC rules are defined by the general PCRF node. In other words, same IP-CAN bearer may be controlled by multiple PCRF nodes. For example, the general PCRF may define the default PCC rules for the IP-CAN bearer, and for IP Multimedia Services (IMS) a specialized PCRF provisions more specific PCC rules for IMS control. A single PCRF may not be able to connect to all possible AF nodes due to interoperability issues (i.e. usage of proprietary procedures in Rx interface), security (operator or service provider security policy does not allow Rx interface between PCRF and AF) or due to scalability issues (PCRF cannot handle all possible AF connections). In summary, there is a need to have multiple PCRF nodes controlling the same IP-CAN bearer, but the current PCC architecture does not allow this.

Partitioning of Diameter-based interface to many Diameter servers may be relevant also in other interfaces than Gx. Similar partitioning may be needed also for Gy, where some parts of the credit control are managed by special servers and general usage is handled in another server. For example, a certain service may be managed by independent service provider A, which operates in operator network. In this situation, the operator services could be managed by operator OCS while the services related to some specific rating groups and service identifiers are managed by OCS of the service provider A.

As prior art solution for dependencies between Gy and Gx interfaces, it has been suggested that some of the AVPs used in Gy interface for reporting usage will be used also in the Gx interface. One alternative is to actually combine Gx and Gy to a single interface and same server implements both OCS and PCRF functions. This solution is not always technically feasible, because then the new OCS&PCRF product becomes quite a complex product. Thus, the manufactures of these elements may prefer to leave OCS and PCRF products as completely separate products.

Another alternative is that OCS and PCRF are kept as separate products, but usage reporting in the Gx interface for PCRF is used only for implementing the fair usage policies. This still complicates the PCRF implementation. Another problem related to this approach is that PCRF is not OCS, so it does not have all the information the OCS has. If PCRF has no interface to the rating engine or subscriber account, it does not actually know subscriber account balance, which may have impact on the policies (e.g. when account is almost empty, policies may need to be changed). If PCRF has no interface to repository, which contains information about the past usage, PCRF cannot make policy decisions based on the usage in the past IP-CAN bearers (e.g. Defining fair usage policies based on monthly usage). If, however, PCRF has interfaces to rating engine, subscriber account or past usage repositories, then overall system architecture becomes more complex, because both OCS and PCRF have interfaces to those functions and unwanted dependencies may be raised between OCS and PCRF.

### SUMMARY OF THE INVENTION

Thus, it is an object of the present invention to overcome the shortcomings of the prior art.

According to several embodiments of the present invention, an information element for a first server controlling a first session according to an authentication, authorization and accounting protocol related to a bearer is generated, wherein the information element indicates that there is at least one second session according to the authentication, authorization and accounting protocol with at least one second server related to the same bearer, and that delegation of the first and the at least one second sessions is allowed.

Alternatively an information element to be sent from a first server to at least one second server which are connected to a client is generated, wherein there is a first session according to an authentication, authorization and accounting protocol with the client related to a bearer, and the information element includes information for at least one second session according to the authentication, authorization and accounting protocol related to the same bearer, and wherein delegation of the first and the at least one second sessions is allowed.

### BRIEF DESCRIPTION OF THE DRAWINGS

These and other objects, features, details and advantages will become more fully apparent from the following detailed description of embodiments of the present invention which is to be taken in conjunction with the appended drawings, in which:

FIG. 1 shows a structure of several network elements according to an embodiment of the present invention;

FIG. 2 shows a signaling flow illustrating a use case for fair usage policy in a scenario where PCEF has Diameter sessions connected to OCS and PCRF according to an embodiment of the invention;

FIG. 3 shows a further signaling flow illustrating a use case for fair usage policy in a scenario where PCEF opens Diameter session to PCRF only based on request coming from OCS according to an embodiment of the invention;

FIG. 4 shows a signaling flow illustrating a use case for multiple Gx sessions per IP-CAN bearer (partitioning of the Gx interface) according to an embodiment of the invention; and

FIG. 5 shows the PCC architecture in 3GPP/SAE.

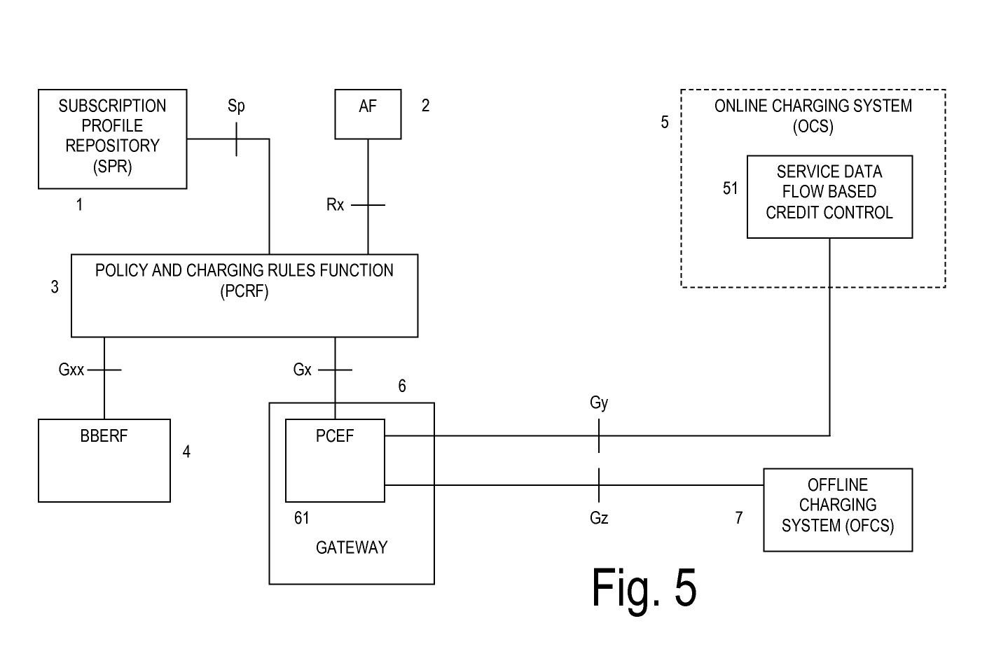

### DETAILED DESCRIPTION OF EMBODIMENTS

In the following, description will be made to embodiments of the present invention. It is to be understood, however, that the description is given by way of example only, and that the described embodiments are by no means to be understood as limiting the present invention thereto.

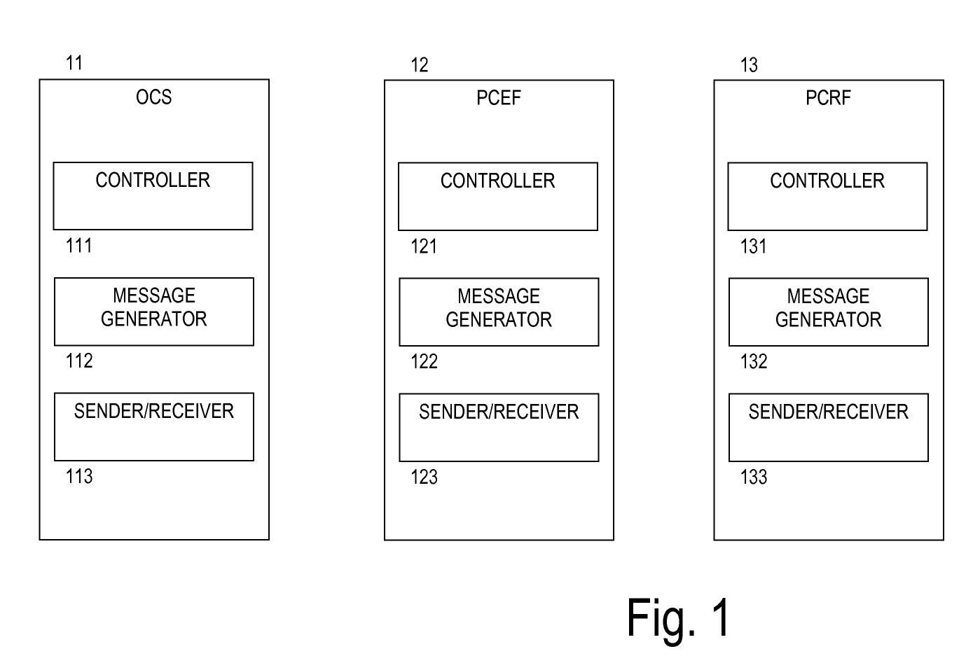

FIG. 1 shows structures of the network elements as used in embodiments described in the following.

Reference number 11 shows an OCS as an example for a first server. The OCS comprises a controller 111 which may perform the overall control of the OCS, including a control over a Diameter session. Furthermore, a message generator 112 is provided which generates messages such as Diameter requests or the like, which may comprise a delegate AVP as an example for an information element. It is noted that the controller 111 and the message generator 112 may be provided as one unit. Furthermore, the OCS comprises a sender/receiver 113, by which messages can be received or sent. The sender/receiver may be a physical interface, a connector or the like. It may also be provided as separate receiver and sender.

Reference number 12 shows an PCEF as an example for a client. The PCEF comprises a controller 121 which may perform the overall control of the PCEF, including a control over a Diameter session. Furthermore, a message generator 122 is provided which generates messages such as Diameter requests or the like, which may comprise a delegated AVP or a delegated AVP as examples for an information element. It is noted that the controller 121 and the message generator 122 may be provided as one unit, e.g., such that the controller performs the control and generates the messages. Furthermore, the PCEF comprises a sender/receiver 123, by which messages can be received or sent. The sender/receiver may be a physical interface, a connector or the like. It may also be provided as separate receiver and sender.

Reference number 13 shows an PCRF as an example for a second server. The PCRF comprises a controller 131 which may perform the overall control of the PCRF, including a control over a Diameter session. Furthermore, a message generator 132 is provided which generates messages such as Diameter requests or the like, which may comprise a delegated AVP as an example for an information element. It is noted that the controller 131 and the message generator 132 may be provided as one unit, e.g., such that the controller performs the control and generates the messages. In the PCRF as an example for the second server, the message generator 132 for generating the delegate AVPs does not necessarily have to be provided as long as this PCRF only acts as a second server which only receives the above-described information elements. Furthermore, the PCEF comprises a sender/receiver 133, by which messages can be received or sent. The sender/receiver may be a physical interface, a connector or the like. It may also be provided as separate receiver and sender.

Examples of the invention can be summarized as follows:
Diameter client can indicate to Diameter server that it has another related Diameter sessions connected to other Diameter servers.
Based on this information, Diameter server can delegate opaque data or control the other session.
Diameter server may also create or terminate Diameter sessions connected to other Diameter servers based on delegation.

A more comprehensive list of features of examples is as follows:
A new AVP, delegated AVP, is defined for passing information for Diameter server about all related Diameter sessions in the Diameter client. Diameter client will include delegated AVP in the requests it sends to Diameter server when a new related Diameter session is created or removed. Diameter client uses delegated AVP to inform Diameter servers about those Diameter sessions, where delegation is allowed.
Policies can be configured locally in Diameter client or it may receive those policies from external server to define what kind of delegation is allowed in Diameter client. For example, delegation policy may define that delegation is allowed only from OCS to PCRF and not from PCRF from OCS, or that delegation is allowed only between certain Diameter server nodes (e.g. not between nodes in different Diameter realms).
A new AVP, delegate AVP, is defined for passing opaque data from one Diameter server to another Diameter server between separate Diameter sessions, which are connected to the same Diameter client. When Diameter client receives opaque data in delegate AVP, the opaque data is sent to the other Diameter server in delegate AVP.
The opaque data passed in delegate AVP is used to define fair usage policies.
The opaque data passed in delegate AVP is used to partition the interface.
Diameter server may initiate a new Diameter session based on the delegate AVP. The new Diameter session may use another Diameter application or same Diameter application.
When Diameter client receives delegate AVP, it may convert this delegate AVP to native AVPs of the interface whenever it is technically possible.

In the following, some use cases of embodiments of the present invention are described.

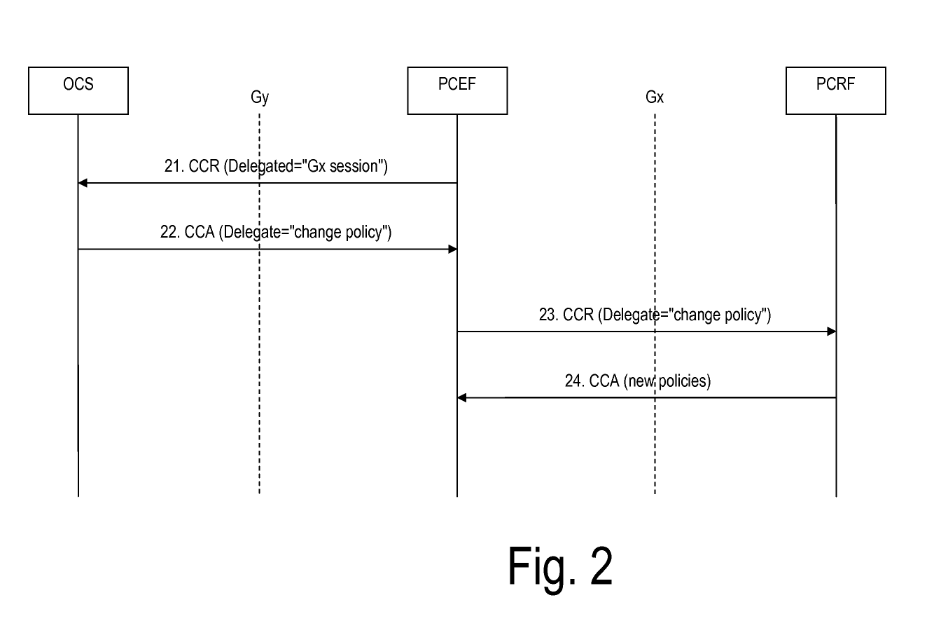

FIG. 2 shows how according to an embodiment the fair usage policy problem is solved, and shows a signaling flow in a scenario where PCEF has Diameter sessions connected to OCS and PCRF according to an embodiment of the invention.

As pre-condition in this example, there are already active sessions related to the same IP-CAN bearer in the Gx and Gy interfaces. First message 21 represents a CCR (credit control request), which was sent e.g. because usage limit given in earlier CCA (credit control answer) message has been used and PCEF is requesting new quota with CCR. The CCR contains also the delegated AVP, which indicates that there is an active session related to the same IP-CAN bearer in the Gx interface and delegation to this Gx session is allowed. OCS detects that usage limit (e.g. monthly usage) has been exceeded and new policies should be given by PCRF. OCS will return delegate AVP in the CCA in message 22. PCEF will send CCR over Gx interface to PCRF in message 23, which will contain the delegation command from the delegate AVP received from OCS. This delegation command consists of AVPs, which indicate to PCRF that OCS has detected that usage limit has exceeded. PCRF determines what is the new policy in this situation and provisions the new policies in a CCA message 24.

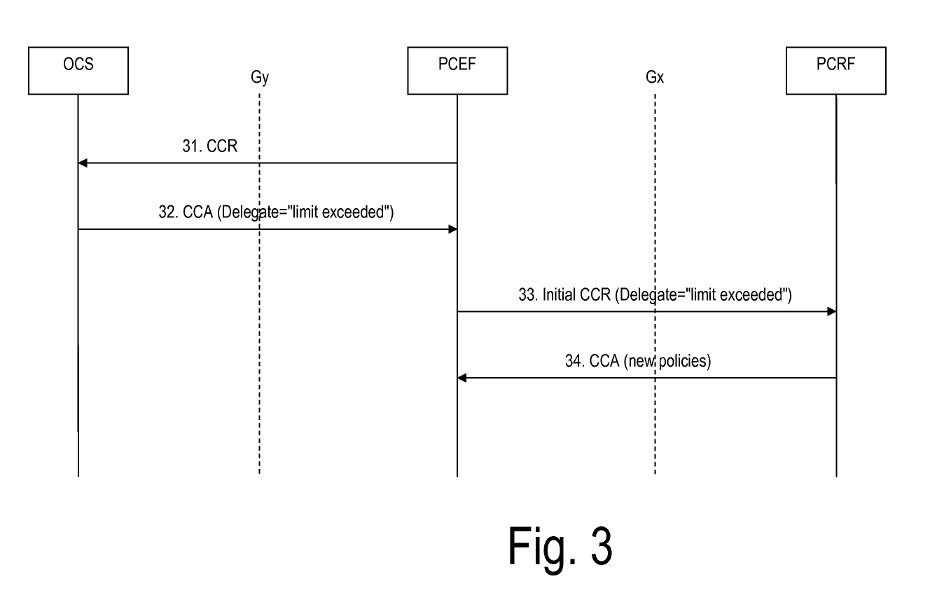

FIG. 3 shows the use case related to the scenario where there is no active Gx session before message 33. In detail, FIG. 3 shows a signaling flow illustrating a use case for fair usage policy in a scenario where PCEF opens Diameter session to PCRF only based on request coming from OCS according to an embodiment of the invention.

In this case, the CCR message 31 does not contain delegated AVP, because there are no other active sessions related to the same IP-CAN bearer. The delegate AVP in the CCA message 32 will then instruct PCEF to create a new Gx session towards PCRF indicated in the delegate AVP and the initial CCR message 33 will inform PCRF that Gx session was created due to usage limit event detected in OCS.

It is noted that in this particular case, the server (OCS/PCRF) does not have to know the other server where the delegate command should be sent, since as there is no active Gx session, there is nothing to delegate. If and when another session is created, the delegated AVP can be used to indicate this in the next CCR and this event could even trigger sending of CCR. Moreover, when a server creates a new Diameter session based on delegation (as effected in the example of FIG. 3 with message 32), then the original server can get information about the other server e.g. from SPR.

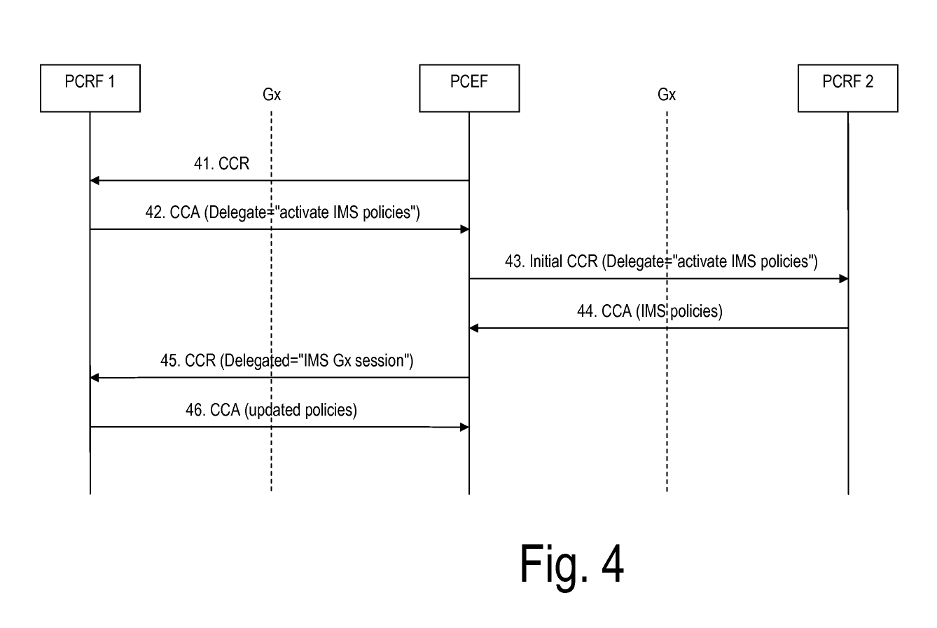

FIG. 4 shows a further use case: multiple Gx sessions per IP-CAN bearer (partitioning of Gx interface).

The other problem was to define multiple Gx sessions per same IP-CAN bearer. Following diagram illustrates how the invention can be used to define two Gx sessions for the same IP-CAN bearer, where the first Gx session is for defining the general PCC rules for the IP-CAN bearer and the second Gx session is used to define specific IMS PCC rules. Initially, the PCEF has only Gx session in PCRF 1 (i.e., the first PCRF), which is the general PCRF node. PCEF sends CCR message 41 to PCRF 1, which then gives in the CCA message 42 delegate AVP. PCEF will create another Gx session to PCRF 2 (i.e., the second PCRF) with CCR message 43 and PCRF 2 defines the IMS PCC rules in CCA message 44. Delegate AVP may contain AVPs, which define the scope of control for PCRF 2, i.e. PCRF shall then not define PCC rules, which it is not allowed to define, because those PCC rules are controlled by PCRF 1. Later, PCEF may send a next CCR message 45 to PCRF 1 and this message will then indicate to PCRF 1 that there is another Gx session where delegation is allowed. The PCRF 1 will then respond with CCA message 46, in which updated policies are informed.

The partitioning of Gy interface can be done in a similar way as partitioning of Gx interface. The only difference is that PCRF 1 is replaced with OCS 1, PCRF 2 is replaced with OCS 2, and OCS 1 indicates to PCEF in the delegate AVP that certain rating groups and service identifiers are managed in OCS 2. In this case, the PCEF may convert the received delegate AVP to native AVPs of Gy interface and there is actually no need to send delegate AVP from PCEF to OCS.

It is further noted that in the above-described examples of FIGS. 2 and 3, the OCS is the master of decisions related to online charging and PCRF is master for policy control decisions. If there is delegation between two PCRFs, as in the example of FIG. 4, the PCRF which adds additional Gx sessions should indicate the scope of delegation.

In the following, an implementation of the two new AVPs is described.

Delegated AVP

Delegated AVP is defined as grouped AVP, which means that the AVP consists of other AVPs. Delegated AVP may have following definition:

$$Delegated :: = 〈 AVP Header 〉 \{ Destination \text{-} Host \} \{ Destination \text{-} Realm \} [ Auth \text{-} Application \text{-} Id ] [ Acct \text{-} Application \text{-} Id ] [ Vendor \text{-} Specific \text{-} Application \text{-} Id ] \{ Session \text{-} Id \} [ Delegated \text{-} Status ]$$

One delegated AVP identifies one Diameter session, which is related to Diameter session, where the AVP is passed. AVPs inside delegated AVP are:
Destination-Host and Destination-Realm AVP identify the Diameter server, which handles the related Diameter session.
Auth-Application-Id, Acct-Application-Id or Vendor-Specific-Application-Id identifies the application related to the session. Only one of the AVPs is present depending on the type of the delegated Diameter session.
Session-Id is the session identifier of the other Diameter session, where delegation is allowed.

Delegated-Status AVP defines the status of the delegated Diameter session. Following values may be used in delegated-Status AVP:
ADD (0)—a new Diameter session has been created in Diameter client, where delegation is allowed.
REMOVE (1)—the Diameter session of delegated AVP has been removed or delegation is no longer allowed in this Diameter session.

Delegate AVP

Delegate AVP is grouped AVP. It has following definition when it is sent from Diameter server to Diameter client:

$$Delegate :: = 〈 AVP Header 〉 \{ Destination \text{-} Host \} \{ Destination \text{-} Realm \} [ Auth \text{-} Application \text{-} Id ] [ Acct \text{-} Application \text{-} Id ] [ Vendor \text{-} Specific \text{-} Application \text{-} Id ] [ Session \text{-} Id ] \{ Delegate \text{-} Command \}$$

Destination-Host and Destination-Realm identify the Diameter server, which should receive the delegated command. If Delegate-Command is ADD, these AVPs may be missing, and then the Diameter client should select the Diameter server based on its local configuration.
Auth-Application-Id, Acct-Application-Id or Vendor-Specific-Application-Id identifies the application identifier of the Diameter session, where the delegate command should be sent.
Session-Id identifies the session where the delegate command should be sent. If no Session-Id is included, the delegate-Command should be ADD.

Delegate-Command is grouped AVP, which defines the requested action related to another Diameter session:

$$Delegate \text{-} Command :: = 〈 AVP Header 〉 \{ Delegate \text{-} Action \} [ Delegate \text{-} Data ]$$

Delegate-Action has following values:
ADD (0)—Diameter client should create a new Diameter session.
REMOVE (1)—Diameter client should terminate Diameter session identified by Session-Id.
PASS (2)—Delegate-Data should be passed to existing Diameter session identified by Session-Id.

Delegate-data AVP is grouped AVP, which contains the AVPs, which are passed to the delegated session. Any AVP may be inside the Delegate-Data AVP, and the meaning of those AVPs depends on the delegation use case. If Delegate-Action is ADD, then Delegate-Data is sent in the request, which creates the new session. If Delegate-Action is REMOVE, then Delegate-Data is sent in the request, which terminates the session. If Delegate-Action is PASS, then Delegate-Data is sent in the next request related to the delegated session (depending on the application, request may be initiated based on delegation or delegation data is buffered until next request is sent).

If Delegate-Action is ADD or REMOVE, the delegate-data may contain AVPs, which define when the Diameter session is created or removed.

When delegate AVP is sent from Diameter client to Diameter server, it contains slightly different AVPs:

$$Delegate :: = 〈 AVP Header 〉 \{ Origin \text{-} Host \} \{ Origin \text{-} Realm \} [ Auth \text{-} Application \text{-} Id ] [ Acct \text{-} Application \text{-} Id ] [ Vendor \text{-} Specific \text{-} Application \text{-} Id ] \{ Session \text{-} Id \} \{ Delegate \text{-} Command \}$$

Origin-Host and Origin-Realm identify the Diameter server, from which the Diameter client received the delegate AVP.
Auth-Appliction-Id, Acct-Application-Id or Vendor-Specific-Application-Id identify the Diameter session, from which the delegate AVP originated.
Session-Id identifies the Diameter session, from which the delegate AVP originated.
Delegate-Command has same value as in the original delegate AVP.

The above described embodiment, which is applied to Diameter as an example, is very simple to implement, because it requires only addition of couple of new AVPs, which can be used in any Diameter message. Even though the above examples show only usage of delegate AVP and delegated AVP in CCR and CCA messages, the new AVPs can be used in any other Diameter message. The new AVPs can be used also in any Diameter application, and the AVPs can be used to define delegation between sessions of any Diameter applications. The embodiment also allows delegation between multiple active Diameter sessions, because single Diameter message may contain multiple delegate and delegated AVPs. Thus, the embodiment provides a very powerful new functionality, which can be used to solve problems related to dependencies between multiple Diameter sessions as long as those Diameter sessions are terminated in the same Diameter client.

If the solution according to the embodiment is compared to solution where interfaces are defined between Diameter servers so that they can delegate directly information without passing data to Diameter client, the embodiment provides many advantages. The usage of Diameter client as an exchange point for delegation guarantees that delegation is synchronized. For example, QoS change may trigger CCR message from PCEF to both OCS and PCRF. If delegation is done using direct interface between OCS and PCRF, PCEF may request new PCC rules from PCRF and receive (no) update from PCC rules PCRF if OCS has not yet delegated to PCRF the need to update policies due to usage limit related to the new QoS. If the solution according to the embodiment is used, however, PCEF may delay sending of CCR until it has received CCA with possible delegation from the OCS. Furthermore, if there are multiple OCS and PCRF nodes, OCS (or PCRF) node does not know which PCRF (or OCS) node handles the related Gx (or Gy) session. With the embodiment this problem is avoided, because delegated AVP indicates what are the other active Diameter sessions and which Diameter server is handling those Diameter sessions. Delegation actually allows making also the direct interface between related Diameter servers, because based on the delegated AVP the server knows which the related servers are.

The embodiments described above can also be applied to a situation in which the servers and/or the client belong to different networks (home/visited). Namely, the delegated AVP may contain destination-host and destination-realm AVPs, and based on these AVPs the Diameter server (e.g. OCS in the examples of FIGS. 2 and 3) can determine whether delegation should be used. Delegate AVP may also contain origin-host and origin-realm AVPs, which identify the Diameter server, where the AVP was originated, and based on this information the target server (e.g. PCRF in the examples of FIGS. 2 and 3) can decide, whether it will accept the AVP. The actual delegation is anyway always possible, because Diameter client has already Diameter sessions in both servers, so it can pass AVPs from one server to another.

The embodiment described above is not limited to the Diameter protocol. It can be applied to any other suitable protocol, in particular any authentication, authorization and accounting protocol.

In the following, several embodiments of the invention are described in generic terms by referring to several aspects thereof.

According to a first aspect of several embodiments of the invention, an apparatus is provided which comprises a controller configured to control a first session according to an authentication, authorization and accounting protocol with a first server related to a bearer, and a message generator configured to generate an information element for the first server, the information element indicating that there is at least one second session according to the authentication, authorization and accounting protocol with at least one second server related to the same bearer, and that delegation of the first and the at least one second sessions is allowed.

The first aspect may be modified as follows:

The message generator may be configured to generate the information element when a new related session is created or removed.

The information element may comprise a session identification of the at least one second session.

The controller may be configured to configure policies in order to define what kind of delegation is allowed with respect to the first and/or at least one second sessions.

The controller may be configured to receive policies from the first server and/or the at least one second server in order to define what kind of delegation is allowed with respect to the first and/or at least one second sessions.

The apparatus according to the first aspect may be provided in a Diameter client, for example in a policy and charging enforcement function (PCEF).

According to a second aspect of embodiments of the present invention, an apparatus is provided which comprises a controller configured to control a first session according to an authentication, authorization and accounting protocol with a client related to a bearer and to perform a server functionality, a message generator configured to generate an information element for at least one second server connected to the client for at least one second session according to the authentication, authorization and accounting protocol related to the same bearer, wherein delegation of the first and the at least one second sessions is allowed.

The second aspect may be modified as follows:

The information element may comprise data opaque to the client.

The information element may comprise information for controlling the session between the at least one second server and the client.

Furthermore, the message generator may be configured to generate the information element after receiving a message including an information element indicating that there is at least one second session according to the authentication, authorization and accounting protocol with the at least one second server related to the same bearer.

In addition, in the first and second aspects, the message generator may be configured to include the information element into a message.

According to a third aspect of embodiments of the present invention, an apparatus is provided which comprises controller configured to control a first session according to an authentication, authorization and accounting protocol with a first server related to a bearer and to perform a client functionality, a receiver configured to receive an information element for a second server for a second session according to the authentication, authorization and accounting protocol related to the same bearer, wherein delegation of the first and the at least one second sessions is allowed, and a sender configured to send the information element to the second server.

The third aspect may be modified as follows:

The information element may comprise data opaque to the apparatus.

The information element may comprise information for controlling the at least one second session between the at least one second server and the apparatus.

The controller may be configured to create a new session to the second server after receiving the message including the information element from the first server in case there is no session with the second server.

The sender may be configured to send a message including the information element.

According to a fourth aspect of several embodiments of the invention, an apparatus is provided which comprises means for controlling a first session according to an authentication, authorization and accounting protocol with a first server related to a bearer, and means for generating an information element for the first server, the information element indicating that there is at least one second session according to the authentication, authorization and accounting protocol with at least one second server related to the same bearer, and that delegation of the first and the at least one second sessions is allowed.

The fourth aspect may be modified as follows:

The apparatus may further comprise means for generating the information element when a new related session is created or removed.

The information element may comprise a session identification of the at least one second session.

The apparatus may further comprise means for configuring policies in order to define what kind of delegation is allowed with respect to the first and/or at least one second sessions.

The apparatus may further comprise means for receiving policies from the first server and/or the at least one second server in order to define what kind of delegation is allowed with respect to the first and/or at least one second sessions.

The apparatus according to the fourth aspect may be provided in a Diameter client, for example in a policy and charging enforcement function (PCEF).

According to a fifth aspect of embodiments of the present invention, an apparatus is provided which comprises means for controlling a first session according to an authentication, authorization and accounting protocol with a client related to a bearer and for performing a server functionality, and means for generating an information element for at least one second server connected to the client for at least one second session according to the authentication, authorization and accounting protocol related to the same bearer, wherein delegation of the first and the at least one second sessions is allowed.

The fifth aspect may be modified as follows:

The information element may comprise data opaque to the client.

The information element may comprise information for controlling the session between the at least one second server and the client.

Furthermore, the apparatus may comprise means for generating the information element after receiving a message including an information element indicating that there is at least one second session according to the authentication, authorization and accounting protocol with the at least one second server related to the same bearer.

In addition, in the fourth and fifth aspects, the apparatus may comprise means for including the information element into a message.

According to a sixth aspect of several embodiments of the present invention, an apparatus is provided which comprises means for controlling a first session according to an authentication, authorization and accounting protocol with a first server related to a bearer and for performing a client functionality, means for receiving an information element for a second server for a second session according to the authentication, authorization and accounting protocol related to the same bearer, wherein delegation of the first and the at least one second sessions is allowed, and means for sending the information element to the second server.

The sixth aspect may be modified as follows:

The information element may comprise data opaque to the apparatus.

The information element may comprise information for controlling the at least one second session between the at least one second server and the apparatus.

The apparatus may comprise means for creating a new session to the second server after receiving the message including the information element from the first server in case there is no session with the second server.

The apparatus may comprise means for sending a message including the information element.

According to a seventh aspect of several embodiments of the present invention, a method is provided which comprises controlling a first session according to an authentication, authorization and accounting protocol between a client and a first server related to a bearer, and generating an information element for the first server, the information element indicating that there is at least one second session according to the authentication, authorization and accounting protocol with at least one second server related to the same bearer, and that delegation of the first and the at least one second sessions is allowed.

The seventh aspect may be modified as follows:

The method, in particular the controlling and the generating, may be carried out by the client.

The information element may be generated when a new related session is created or removed.

The information element may comprise a session identification of the at least one second session.

The method may further comprise configuring policies in order to define what kind of delegation is allowed with respect to the first and/or at least one second sessions.

The method may further comprise receiving policies from the first server and/or the at least one second server in order to define what kind of delegation is allowed with respect to the first and/or at least one second sessions.

According to an eighth aspect of several embodiments of the present invention, a method is provided which comprises controlling a first session according to an authentication, authorization and accounting protocol with a client related to a bearer in a server, and generating an information element for at least one second server connected to the client for at least one second session according to the authentication, authorization and accounting protocol related to the same bearer, wherein delegation of the first and the at least one second sessions is allowed.

The eighth aspect may be modified as follows:

The information element may comprise data opaque to the client.

The information element may comprise information for controlling the session between the at least one second server and the client.

Moreover, the information element is generated after receiving a message including an information element indicating that there is at least one second session according to the authentication, authorization and accounting protocol with the at least one second server related to the same bearer.

In the seventh and eight aspects, in the generating of the information element, the information element may be included into a message.

According to a ninth aspect of several embodiments of the present invention, a method is provided which comprises controlling a first session according to an authentication, authorization and accounting protocol with a first server related to a bearer in a client, and receiving an information element for a second server for a second session according to the authentication, authorization and accounting protocol related to the same bearer, wherein delegation of the first and the at least one second sessions is allowed, and sending the information element to the second server.

The ninth aspect may be modified as follows:

The information element may comprise data opaque to the client.

The information element may comprise information for controlling the at least one second session between the at least one second server and the client.

The method may further comprise creating a new session to the second server after receiving the message including the information element from the first server in case there is no session with the second server.

In the sending of the information element, the information element is included in a message.

According to a tenth aspect of several embodiments of the present invention, a computer program product is provided which comprises code means for performing a method according any of the above seventh to ninth aspects or their modifications when run on a processing means or module.

According to an eleventh aspect of several embodiments of the present invention, a data structure is provided which comprises an information element for a first server controlling a first session according to an authentication, authorization and accounting protocol related to a bearer, the information element indicating that there is at least one second session according to the authentication, authorization and accounting protocol with at least one second server related to the same bearer, and that delegation of the first and the at least one second sessions is allowed.

According to a twelfth aspect of several embodiments of the present invention, a data structure is provided which comprises an information element, to be sent from a first server to at least one second server which are connected to a client, wherein there is a first session according to an authentication, authorization and accounting protocol with the client related to a bearer, the information element including information for at least one second session according to the authentication, authorization and accounting protocol related to the same bearer, wherein delegation of the first and the at least one second sessions is allowed.

In the first to twelfth aspects, the authentication, authorization and accounting protocol may be a Diameter protocol, the sessions according to the authentication, authorization and accounting protocol may be Diameter sessions, and the information element may be an attribute-value pair.

For the purpose of the present invention as described herein above, it should be noted that
method steps likely to be implemented as software code portions and being run using a processor at a network element or terminal (as examples of devices, apparatuses and/or modules thereof, or as examples of entities including apparatuses and/or modules therefore), are software code independent and can be specified using any known or future developed programming language as long as the functionality defined by the method steps is preserved;
generally, any method step is suitable to be implemented as software or by hardware without changing the idea of the invention in terms of the functionality implemented;
method steps and/or devices, units or means likely to be implemented as hardware components at the above-defined apparatuses, or any module(s) thereof, (e.g., devices carrying out the functions of PCRF, PCEF, OCS etc. as described above) are hardware independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components;
devices, units or means (e.g. the above-defined apparatuses, or any one of their respective means) can be implemented as individual devices, units or means, but this does not exclude that they are implemented in a distributed fashion throughout the system, as long as the functionality of the device, unit or means is preserved;
an apparatus may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor;
a device may be regarded as an apparatus or as an assembly of more than one apparatus, whether functionally in cooperation with each other or functionally independently of each other but in a same device housing, for example.

What is described above is what is presently considered to be preferred embodiments of the present invention. However, as is apparent to the skilled reader, these are provided for illustrative purposes only and are in no way intended that the present invention is restricted thereto. Rather, it is the intention that all variations and modifications be included which fall within the spirit and scope of the appended claims.

1. An apparatus comprising
a controller configured to control a first session according to an authentication, authorization and accounting protocol with a first server related to a bearer, and
a message generator configured to generate an information element for the first server, the information element indicating that there is at least one second session according to the authentication, authorization and accounting protocol with at least one second server related to the same bearer, and that delegation of the first and the at least one second sessions is allowed.

2. The apparatus according to claim 1, wherein the message generator is configured to generate the information element when a new related session is created or removed.

3. The apparatus according to claim 1, wherein the information element comprises a session identification of the at least one second session.

4. The apparatus according to claim 1, wherein the controller is configured to configure policies in order to define what kind of delegation is allowed with respect to the first and/or at least one second sessions.

5. The apparatus according to claim 1, wherein the controller is configured to receive policies from the first server and/or the at least one second server in order to define what kind of delegation is allowed with respect to the first and/or at least one second sessions.

6. An apparatus comprising
a controller configured to control a first session according to an authentication, authorization and accounting protocol with a client related to a bearer and to perform a server functionality, and
a message generator configured to generate an information element for at least one second server connected to the client for at least one second session according to the authentication, authorization and accounting protocol related to the same bearer, wherein delegation of the first and the at least one second sessions is allowed.

7. The apparatus according to claim 6, wherein the information element comprises data opaque to the client.

8. The apparatus according to claim 6, wherein the information element comprises information for controlling the session between the at least one second server and the client.

9. The apparatus according to claim 6, wherein the message generator is configured to generate the information element after receiving a message including an information element indicating that there is at least one second session according to the authentication, authorization and accounting protocol with the at least one second server related to the same bearer.

10. An apparatus comprising
a controller configured to control a first session according to an authentication, authorization and accounting protocol with a first server related to a bearer and to perform a client functionality,
a receiver configured to receive an information element for a second server for a second session according to the authentication, authorization and accounting protocol related to the same bearer, wherein delegation of the first and the at least one second sessions is allowed, and
a sender configured to send the information element to the second server.

11. The apparatus according to claim 10, wherein the information element comprises data opaque to the apparatus.

12. The apparatus according to claim 10, wherein the information element comprises information for controlling the at least one second session between the at least one second server and the apparatus.

13. The apparatus according to claim 10, wherein the controller is configured to create a new session to the second server after receiving the message including the information element from the first server in case there is no session with the second server.

14. The apparatus according to claim 1, wherein the message generator is configured to include the information element into a message.

15. The apparatus according to claim 10, wherein the sender is configured to send a message including the information element.

16. The apparatus according to claim 1, wherein the authentication, authorization and accounting protocol is a Diameter protocol, the sessions according to the authentication, authorization and accounting protocol are Diameter sessions, and the information element is an attribute-value pair.

17. A method comprising
controlling a first session according to an authentication, authorization and accounting protocol between a client and a first server related to a bearer,
generating an information element for the first server, the information element indicating that there is at least one second session according to the authentication, authorization and accounting protocol with at least one second server related to the same bearer, and that delegation of the first and the at least one second sessions is allowed.

18. The method according to claim 17, wherein the information element is generated when a new related session is created or removed.

19. The method according to claim 17, wherein the information element comprises a session identification of the at least one second session.

20. The method according to claim 17, further comprising configuring policies in order to define what kind of delegation is allowed with respect to the first and/or at least one second sessions.

21. The method according to claim 17, further comprising receiving policies from the first server and/or the at least one second server in order to define what kind of delegation is allowed with respect to the first and/or at least one second sessions.

22. A method comprising
controlling a first session according to an authentication, authorization and accounting protocol with a client related to a bearer in a server, and
generating an information element for at least one second server connected to the client for at least one second session according to the authentication, authorization and accounting protocol related to the same bearer, wherein delegation of the first and the at least one second sessions is allowed.

23. The method according to claim 22, wherein the information element comprises data opaque to the client.

24. The method according to claim 22, wherein the information element comprises information for controlling the session between the at least one second server and the client.

25. The method according to claim 22, the information element is generated after receiving a message including an information element indicating that there is at least one second session according to the authentication, authorization and accounting protocol with the at least one second server related to the same bearer.

26. A method comprising
controlling a first session according to an authentication, authorization and accounting protocol with a first server related to a bearer in a client,
receiving an information element for a second server for a second session according to the authentication, authorization and accounting protocol related to the same bearer, wherein delegation of the first and the at least one second sessions is allowed, and
sending the information element to the second server.

27. The method according to claim 26, wherein the information element comprises data opaque to the client.

28. The method according to claim 26, wherein the information element comprises information for controlling the at least one second session between the at least one second server and the client.

29. The method according to claim 26, further comprising creating a new session to the second server after receiving the message including the information element from the first server in case there is no session with the second server.

30. The method according to claim 17, wherein in the generating of the information element, the information element is included into a message.

31. The method according to claim 26, wherein in the sending of the information element, the information element is included in a message.

32. The method according to claim 17, wherein the authentication, authorization and accounting protocol is a Diameter protocol, the sessions according to the authentication, authorization and accounting protocol are Diameter sessions, and the information element is an attribute-value pair.

33. A computer program product comprising code means for performing a method according to claim 17 when run on a processing means or module.

34. A data structure comprising
an information element for a first server controlling a first session according to an authentication, authorization and accounting protocol related to a bearer, the information element indicating that there is at least one second session according to the authentication, authorization and accounting protocol with at least one second server related to the same bearer, and that delegation of the first and the at least one second sessions is allowed.

35. An data structure comprising
an information element, to be sent from a first server to at least one second server which are connected to a client, wherein there is a first session according to an authentication, authorization and accounting protocol with the client related to a bearer, the information element including information for at least one second session according to the authentication, authorization and accounting protocol related to the same bearer, wherein delegation of the first and the at least one second sessions is allowed.

36. The data structure according to claims 34, wherein the authentication, authorization and accounting protocol is a Diameter protocol, the sessions according to the authentication, authorization and accounting protocol are Diameter sessions, and the information element is an attribute-value pair.
